(19) United States
(12) Patent Application Publication
(10) Pub. No.: US 2026/0002450 A1
(43) Pub. Date: Jan. 1, 2026

(54) SHAFT SEALING DEVICE AND ROTARY MACHINE

(71) Applicant: MITSUBISHI HEAVY INDUSTRIES, LTD., Tokyo (JP)

(72) Inventors: Kohei Ozaki, Tokyo (JP); Hidekazu Uehara, Tokyo (JP); Azumi Yoshida, Tokyo (JP); Yuta Yanase, Tokyo (JP); Shin Nishimoto, Tokyo (JP); Tatsuro Furusho, Tokyo (JP); Kiyoshi Segawa, Tokyo (JP); Takashi Nakano, Tokyo (JP)

(73) Assignee: MITSUBISHI HEAVY INDUSTRIES, LTD., Tokyo (JP)

(21) Appl. No.: 19/320,316

(22) Filed: Sep. 5, 2025

Related U.S. Application Data
(63) Continuation of application No. 18/703,848, filed on Apr. 23, 2024.

(30) Foreign Application Priority Data
May 17, 2022 (JP) 2022-080728

(51) Int. Cl. F01D 11/02; F02C 7/28; F16J 15/44; F16J 15/453

(52) U.S. Cl. CPC F01D 11/02; F02C 7/28; F16J 15/445; F16J 15/453; F05D 2220/31; F05D 2240/55

(57) ABSTRACT

This shaft sealing device is disposed between a rotor and a stator, and partitions an annular space between the outer peripheral surface of the rotor and the inner peripheral surface of the stator into a first axial side and a second axial side. The shaft sealing device comprises fins radially protruding from the rotor toward the stator, and a sealing member radially facing the fins, wherein the sealing member comprises: a first sealing layer formed of a porous abradable material having a first porosity; and a second sealing layer which is stacked on the first sealing layer at a position close to the fins and forms a contact surface with the fins, and is formed of a porous abradable material having a second porosity lower than the porosity of the first sealing layer.

### CROSS-REFERENCE TO RELATED APPLICATION

The present application is a continuation application of U.S. patent application Ser. No. 18/703,848, filed on Apr. 23, 2024, which is a national stage application filed under 35 USC 371 of International Application No. PCT/JP2023/010749, filed Mar. 17, 2023, and which is based upon and claims the benefit of priority from the prior Japanese Patent Application No. 2022-080728, filed on May 17, 2022, the entire contents of which are incorporated herein by reference.

### TECHNICAL FIELD

The present disclosure relates to a shaft sealing device and a rotary machine.

This application claims the priority of Japanese Patent Application No. 2022-080728 filed in Japan on May 17, 2022, the content of which is incorporated herein by reference.

### BACKGROUND ART

A rotary machine such as a gas turbine or a steam turbine includes a shaft sealing device. The shaft sealing device is disposed between a rotor and a stator disposed on an outer side in a radial direction of the rotor and surrounding the rotor. The shaft sealing device partitions a space between the rotor and the stator into one side and the other side in an axial direction along a central axis of the rotor. The shaft sealing device suppresses a leakage of a working fluid from a high-pressure side region through which the working fluid flows on one side in the axial direction to a low-pressure side region on the other side in the axial direction.

In this shaft sealing device, an abradable material may be used. For example, PTL 1 discloses a shaft sealing device including a sealing fin provided in any one of the rotor (rotating unit) and the stator (stationary unit), and a coating layer facing the sealing fin and covering a preform of the rotor or the stator. In this shaft sealing device, a configuration in which an abradable material is used for the coating layer is disclosed. The abradable material has excellent machinability when the abradable material comes into sliding contact with the sealing fin.

### CITATION LIST

### Patent Literature

[PTL 1] Japanese Unexamined Patent Application Publication No. 2013-122227

### SUMMARY OF INVENTION

### Technical Problem

The abradable material as disclosed in PTL 1 is a porous material. Therefore, it is possible to achieve an advantageous effect of suppressing heat generation and vibration when the abradable material comes into sliding contacting with the sealing fin. However, there is a possibility that the abradable material formed of the porous material is progressively thinned due to erosion caused by long-term use. Therefore, there is room for improvement in terms of durability.

The present disclosure provides a shaft sealing device and a rotary machine which can suppress damage caused by erosion and can improve durability while maintaining free-cutting performance.

### Solution to Problem

According to the present disclosure, there is provided a shaft sealing device disposed between a rotor rotatable around a central axis and a stator disposed on an outer side in a radial direction with respect to the rotor, and partitioning an annular space between an outer peripheral surface of the rotor and an inner peripheral surface of the stator into a first side and a second side in an axial direction in which the central axis extends. The shaft sealing device includes a fin protruding from the rotor toward the stator in the radial direction, and a sealing member facing the fin in the radial direction. The sealing member includes a first sealing layer formed of a porous abradable material having a first porosity, and a second sealing layer laid up with respect to the first sealing layer at a position close to the fin to form a contact surface with the fin, and formed of a porous abradable material having a second porosity lower than the porosity of the first sealing layer.

According to the present disclosure, there is provided a rotary machine including a rotor rotatable around a central axis, a stator disposed on an outer side in a radial direction of the rotor, and the shaft sealing device described above.

### Advantageous Effects of Invention

According to a shaft sealing device and a rotary machine of the present disclosure, damage caused by erosion can be suppressed, and durability can be improved while free-cutting performance is maintained.

### BRIEF DESCRIPTION OF DRAWINGS

FIG. 1 is a schematic configuration diagram of a rotary machine according to an embodiment of the present disclosure.

FIG. 2 is a sectional view of a shaft sealing device according to a first embodiment of the present disclosure.

FIG. 3 is a view illustrating an example of a thermal spraying angle when a first sealing layer of the shaft sealing device in FIG. 2 is formed.

FIG. 4 is a view illustrating an example of a thermal spraying angle when a second sealing layer is formed with respect to the first sealing layer.

FIG. 5 is a view illustrating a feeding speed of a thermal spraying gun when the first sealing layer of the shaft sealing device in FIG. 2 is formed.

FIG. 6 is a view illustrating a feeding speed of the thermal spraying gun when the second sealing layer is formed with respect to the first sealing layer.

FIG. 7 is a sectional view of a shaft sealing device according to a second embodiment of the present disclosure.

### DESCRIPTION OF EMBODIMENTS

Hereinafter, embodiments of a shaft sealing device and a rotary machine according to the present disclosure will be described with reference to the accompanying drawings. However, the present disclosure is not limited only to the embodiments.

### First Embodiment

### (Configuration of Rotary Machine)

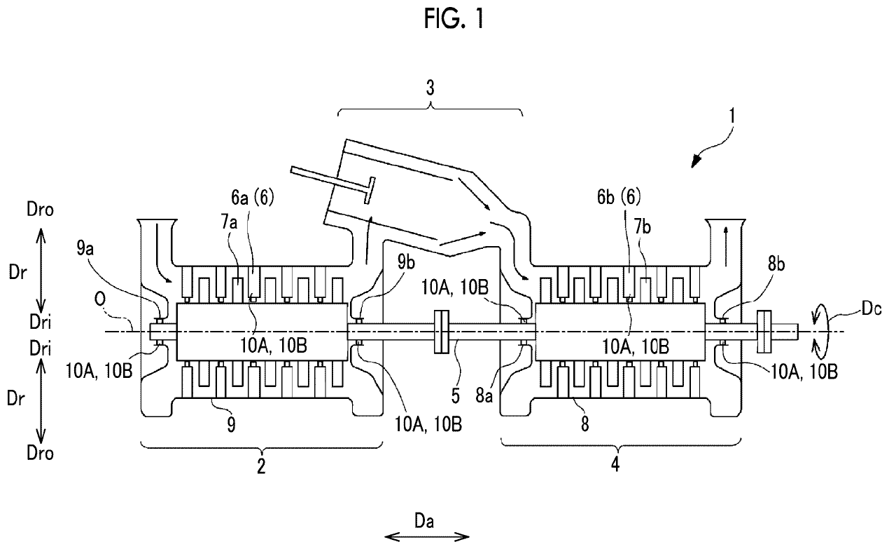

As illustrated in FIG. 1, a rotary machine 1 in the present embodiment is a gas turbine, for example. The rotary machine 1 includes a compressor 2, a combustor 3, a turbine 4, a rotor 5, and a shaft sealing device 10A.

The compressor 2 draws a large amount of air into the compressor 2, and compresses the air. The combustor 3 mixes a fuel with the air compressed by the compressor 2, and combusts the fuel mixed with the air. A combustion gas generated by the combustor 3 is introduced into the turbine 4. The turbine 4 converts thermal energy of the introduced combustion gas into rotational energy, and generates power for rotating the rotor 5 around a central axis O. The rotor 5 extends in a columnar shape in an axial direction Da along the central axis O. The rotor 5 transmits a portion of the power for rotating the turbine 4 to the compressor 2, and drives the compressor 2.

For convenience of the following description, an extending direction of the central axis Ar will be referred to as the axial direction Da. In addition, a radial direction in the rotor 5 or the shaft sealing device 10A with reference to the central axis will be simply referred to as a radial direction Dr. In addition, a side closer to the central axis O in the radial direction Dr will be referred to as an inner side Dri in the radial direction Dr, and a side opposite to the inner side Dri in the radial direction Dr will be referred to as an outer side Dro in the radial direction Dr. In addition, a circumferential direction of the rotor 5 or the shaft sealing device 10A around the central axis O will be simply referred to as a circumferential direction Dc.

The turbine 4 includes a turbine rotor vane 7b, a turbine stator vane 6b serving as a stator 6, and a turbine casing 8. The turbine rotor vane 7b is disposed on the outer side Dro in the radial direction Dr with respect to the rotor 5. The turbine 4 blows a combustion gas to the turbine rotor vane 7b to generate power by converting thermal energy of the combustion gas into mechanical rotational energy. The turbine casing 8 is formed in a tubular shape extending in the axial direction Da. The turbine stator vane 6b is disposed on the inner side Dri in the radial direction Dr with respect to the turbine casing 8. The turbine rotor vane 7b and the turbine stator vane 6b are alternately arranged in the axial direction Da. The turbine rotor vane 7b receives a pressure of the combustion gas flowing in the axial direction of the rotor 5, and rotates the rotor 5 around the axis. The rotational energy applied to the rotor 5 is used after the rotational energy is received from a shaft end.

In the turbine 4, a shaft sealing device 10A is disposed between the turbine stator vane 6b serving as the stator 6 and the rotor 5 to reduce a leakage amount of the combustion gas leaking from a high-pressure side to a low-pressure side.

The compressor 2 is coaxially connected to the turbine 4 via the rotor 5. The compressor 2 uses rotation of the turbine 4, and compresses outside air to generate compressed air. The compressor 2 supplies the generated compressed air to the combustor 3. The compressor 2 includes the compressor stator vane 6a serving as the stator 6, a compressor rotor vane 7a, and a compressor casing 9. The compressor rotor vane 7a is disposed on the outer side Dro in the radial direction Dr with respect to the rotor 5. The compressor casing 9 extends in a tubular shape in the axial direction Da. The compressor stator vane 6a is disposed on the inner side Dri in the radial direction Dr with respect to the compressor casing 9. The compressor rotor vane 7a and the compressor stator vane 6a are alternately arranged in the axial direction Da of the rotor 5.

In the compressor 2, the shaft sealing device 10A for reducing the leakage amount of the compressed air leaking from the high-pressure side to the low-pressure side is also disposed between the compressor stator vane 6a serving as the stator 6 and the rotor 5.

In addition, in bearing portions 9a and 9b for supporting the rotor 5 with respect to the compressor casing 9 and bearing portions 8a and 8b for supporting the rotor 5 with respect to the turbine casing 8, the shaft sealing devices 10A for suppressing a possible leakage of the compressed air or the combustion gas from the high-pressure side to the low-pressure side are also respectively disposed.

### (Configuration of Shaft Sealing Device)

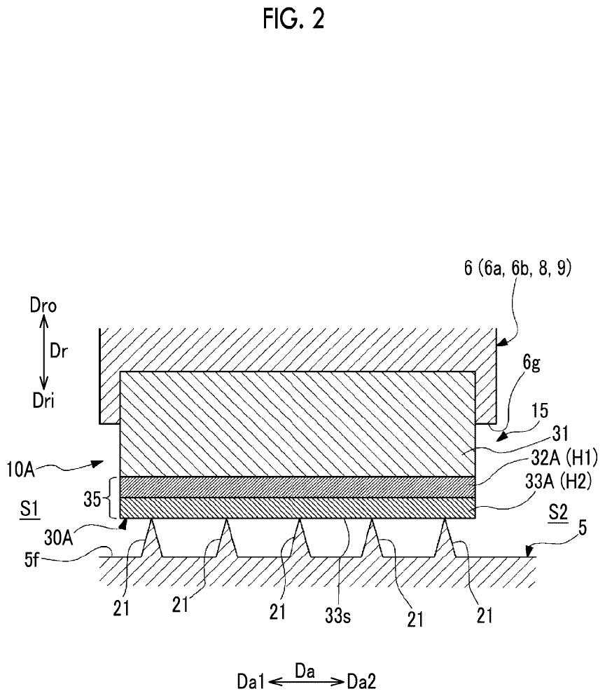

The shaft sealing device 10A seals an annular space between the rotor 5 and the stator 6 covering the rotor 5 to reduce a leakage amount of a fluid leaking from the high-pressure side to the low-pressure side. As illustrated in FIG. 2, the shaft sealing device 10A is disposed between the rotor 5 and the stator 6. In the present embodiment, in the compressor 2, the stator 6 is a turbine stator vane 6b. In the turbine 4, the stator 6 is the turbine stator vane 6b. In addition, for example, in the bearing portions 9a and 9b, the stator 6 is the compressor casing 9 disposed on the outer side Dro in the radial direction Dr of the rotor 5. In addition, for example, the stator 6 is the turbine casing 8 disposed on the outer side Dro in the radial direction Dr of the rotor 5 in the bearing portions 8a and 8b of the turbine 4.

The shaft sealing device 10A is disposed in an annular space 15 between the rotor 5 and the stator 6. The stator 6 is disposed on the outer side Dro in the radial direction Dr with respect to the rotor 5. The rotor 5 has an outer peripheral surface 5f facing the outer side Dro in the radial direction Dr. The stator 6 has an inner peripheral surface 6g facing the inner side Dri in the radial direction Dr. The inner peripheral surface 6g faces the outer peripheral surface 5f of the rotor 5 at an interval in the radial direction Dr. The annular space 15 is formed between the outer peripheral surface 5f of the rotor 5 and the inner peripheral surface 6g of the stator 6. The annular space 15 is formed in an annular shape when viewed in the axial direction Da. The annular space 15 is continuous in the circumferential direction Dc (refer to FIG. 1).

The shaft sealing device 10A partitions the annular space 15 into a first side Da1 and a second side Da2 in the axial direction Da. In the present embodiment, for example, the annular space 15 on the first side Da1 in the axial direction Da with respect to the shaft sealing device 10A is defined as a low-pressure side region S1. The annular space 15 on the second side Da2 in the axial direction Da with respect to the shaft sealing device 10A is defined as a high-pressure side region S2. The low-pressure side region S1 is a region in which a low-pressure fluid (low-pressure gas or liquid) flows. The high-pressure side region S2 is a region in which a high-pressure fluid (high-pressure gas or liquid) having a pressure higher than that of the low-pressure fluid flowing through the low-pressure side region S1 flows. Therefore, in the annular space 15, the shaft sealing device 10A is used as a boundary to generate a flow of the fluid from the high-pressure side region S2 toward the low-pressure side region S1. The shaft sealing device 10A of the present embodiment includes a plurality of fins 21 and a sealing member 30A.

### (Configuration of Fins)

The plurality of fins 21 are disposed on the outer peripheral surface 5f of the rotor 5. The plurality of fins 21 are disposed at an interval in the axial direction Da. Each of the fins 21 is integrally formed on the outer peripheral surface 5f of the rotor 5. Each of the fins 21 continuously extends in the circumferential direction Dc around the central axis O. Each of the fins 21 is formed in an annular shape when viewed in the axial direction Da. The fin 21 protrudes from the rotor 5 toward the stator 6 in the radial direction Dr. That is, each of the fins 21 extends from the outer peripheral surface 5f of the rotor 5 to the outer side Dro in the radial direction Dr. A width dimension of each of the fins 21 in the axial direction Da gradually decreases from the inner side Dri toward the outer side Dro in the radial direction Dr. That is, each of the fins 21 is formed in a tapered shape to become thinner as each of the fins 21 gets closer to a tip.

A cross-sectional shape of each of the fins 21 and a protrusion dimension from the outer peripheral surface 5f to the outer side Dro in the radial direction Dr are not limited to a shape of the present embodiment. The cross-sectional shape of each of the fins 21 and the protrusion dimension from the outer peripheral surface 5f to the outer side Dro in the radial direction Dr can be appropriately changed in accordance with a disposition of the shaft sealing device 10A.

### (Configuration of Sealing Member)

The sealing member 30A is disposed at a position facing the plurality of fins 21 in the radial direction Dr. The sealing member 30A of the present embodiment is disposed on the inner peripheral surface 6g of the stator 6. The sealing member 30A is disposed in a region overlapping the plurality of fins 21 in the axial direction Da. The sealing member 30A has a preform 31, a first sealing layer 32A, and a second sealing layer 33A.

The preform 31 is held on the inner peripheral surface 6g of the stator 6. The preform 31 may be fixed to the inner peripheral surface 6g of the stator 6, or may be held to be relatively movable with respect to the stator 6 in at least one direction of the radial direction Dr, the axial direction Da, and the circumferential direction Dc.

The first sealing layer 32A is disposed on the inner side Dri in the radial direction Dr with respect to the preform 31. The first sealing layer 32A is formed to cover the preform 31 from the inner side Dri in the radial direction Dr.

The second sealing layer 33A is laid up with respect to the first sealing layer 32A at a position close to the fin 21. That is, the second sealing layer 33A is laid up on the inner side Dri in the radial direction Dr with respect to the first sealing layer 32A. The second sealing layer 33A is formed to cover the first sealing layer 32A from the inner side Dri in the radial direction Dr. The second sealing layer 33A forms a contact surface 33s with the plurality of fins 21 of the sealing member 30A. In the present embodiment, the first sealing layer 32A and the second sealing layer 33A have the same thickness in the radial direction Dr.

Each of the first sealing layer 32A and the second sealing layer 33A is formed of a porous abradable material. The abradable material is a material having an easily cuttable characteristic (machinability). In this manner, together with the first sealing layer 32A, the second sealing layer 33A forms an abradable layer 35 in the sealing member 30A. The abradable layer 35 (first sealing layer 32A and second sealing layer 33A) formed of the abradable material can come into contact with the plurality of fins 21 rotating in the circumferential direction Dc together with the rotor 5 during an operation of the rotary machine 1. In this case, the abradable layer 35 is cut by a sliding operation with the plurality of fins 21 rotating in the circumferential direction Dc. The sealing member 30A narrows a clearance between the plurality of fins 21 and the second sealing layer 33A in the radial direction Dr to a contactable level, thereby improving sealing performance between the low-pressure side region S1 and the high-pressure side region S2.

As the abradable material, a porous material softer than a material forming the plurality of fins 21 is used. For example, the abradable material of the present embodiment is a metallic material mainly containing an MCrAIY alloy. “M” of the above-described MCrAlY alloy represents a metal element. For example, the metal element “M” is a single metal element such as NiCo, Ni, and Co, or is a combination of two or more of these elements. More specifically, in the present embodiment, as the abradable material forming the sealing member 30A, for example, an alloy mainly containing a CoNiCrAlY alloy and containing polyester is used. Since a metallic material containing a resin material such as polyester is used, a cavity portion of the porous material is efficiently formed.

The first sealing layer 32A and the second sealing layer 33A are formed of the same material. That is, the first sealing layer 32A and the second sealing layer 33A are formed by using metallic materials having the same composition. The first sealing layer 32A and the second sealing layer 33A are different from each other only in porosity. In the present specification, the fact that the first sealing layer 32A and the second sealing layer 33A are different from each other in porosity while the alloys having the same composition are used is expressed as “formed by the same material”.

In addition, the porosity is obtained in such a manner that the first sealing layer 32A and the second sealing layer 33A are visually confirmed by using a tissue image of a transmission electron microscope (TEM) or a scanning electron microscope (SEM), or in such a manner that an area ratio is calculated by binarizing the first sealing layer 32A and the second sealing layer 33A into black and white.

The first sealing layer 32A has a first porosity H1. The second sealing layer 33A has a second porosity H2 lower than the first porosity H1 of the first sealing layer 32A.

Here, for example, it is preferable that a difference ΔH between the first porosity H1 in the first sealing layer 32A and the second porosity H2 in the second sealing layer 33A is set to 10% or larger and 40% or smaller. In addition, for example, it is preferable that the first porosity H1 in the first sealing layer 32A is set to 60% or larger and 70% or smaller. For example, it is preferable that the second porosity H2 in the second sealing layer 33A is set to 40% or larger and 50% or smaller.

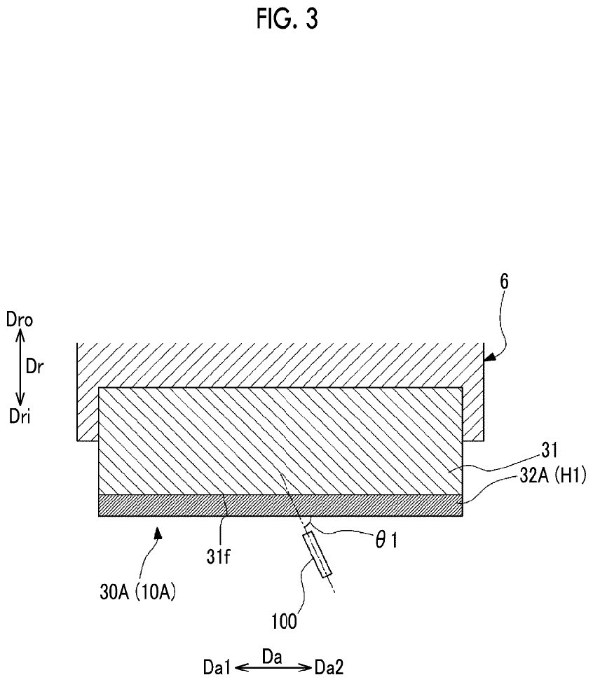

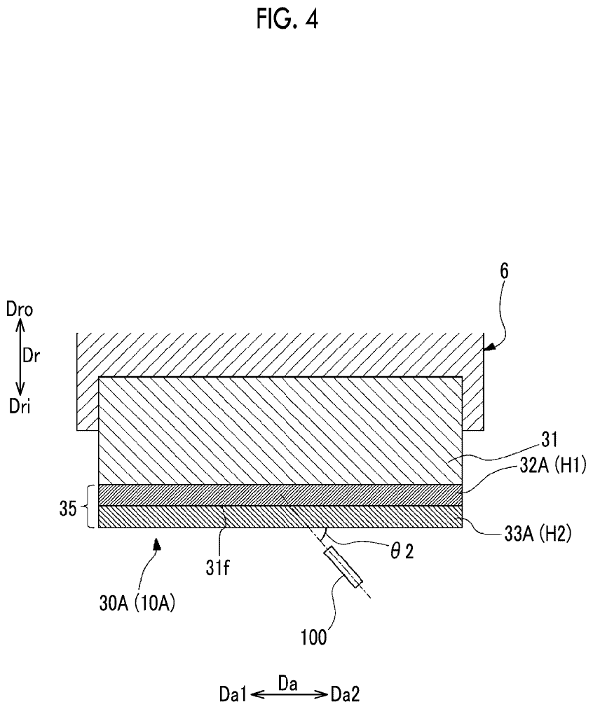

For example, the first sealing layer 32A and the second sealing layer 33A are sequentially formed by thermally spraying a metallic material which is the abradable material as described above, onto the preform 31. Here, for example, a thermal spraying angle of a thermal spraying gun 100 for thermally spraying the metallic material may be changed to change the porosity in the first sealing layer 32A and the second sealing layer 33A. As illustrated in FIG. 3, when the first sealing layer 32A is formed, the thermal spraying angle of the thermal spraying gun 100 is set to a first angle θ1 with respect to a plane direction along a surface 31f facing the inner side Dri in the radial direction Dr in the preform 31. Here, for example, it is preferable that the first angle θ1 is set to 70°≤θ1≤90°. On the other hand, as illustrated in FIG. 4, when the second sealing layer 33A is formed, the thermal spraying angle of the thermal spraying gun 100 is set to a second angle θ2 smaller than the first angle θ1 with respect to the plane direction along the surface 31f of the preform 31. Here, for example, it is preferable that the second angle θ2 is set to 50°≤θ2≤60°. In addition, it is preferable that a difference Δθ(=θ1−θ2) between the first angle θ1 and the second angle θ2 is set to at least 20°.

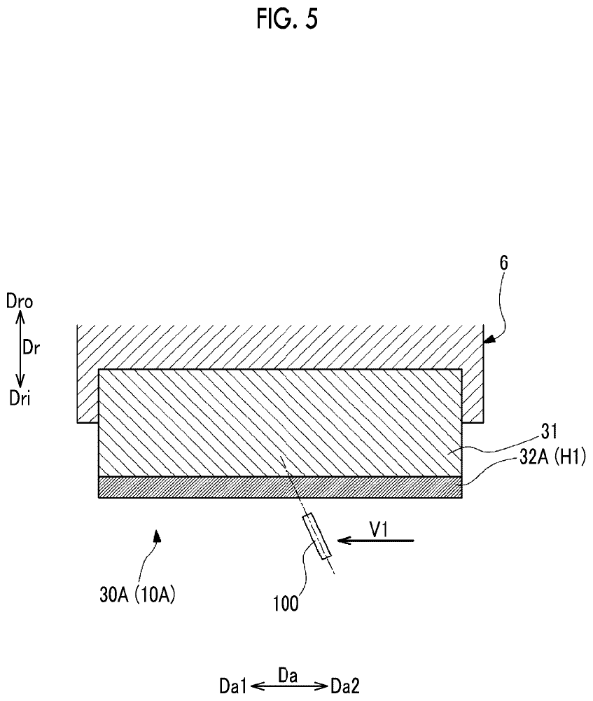

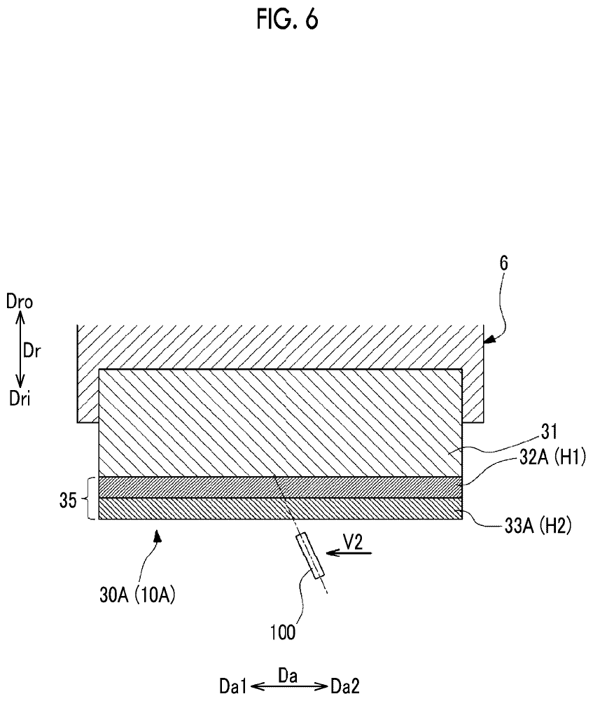

In addition, for example, a moving speed (so-called feeding speed) when thermally spraying is performed by the thermal spraying gun 100 may be changed to change the porosity in the first sealing layer 32A and the second sealing layer 33A. As illustrated in FIG. 5, when the first sealing layer 32A is formed, the moving speed of the thermal spraying gun 100 along the surface 31f of the preform 31 is set to a first speed V1. Here, for example, it is preferable that the first speed V1 is set to 40 m/min≤V1≤50 m/min. As illustrated in FIG. 6, when the second sealing layer 33A is formed, the moving speed of the thermal spraying gun 100 in a direction along the surface 31f of the preform 31 is set to a second speed V2 lower than the first speed V1. Here, for example, it is preferable that the second speed V2 is set to 20 m/min≤V2≤30 m/min. It is preferable that a difference ΔV (=V1−V2) between the first speed V1 and the second speed V2 is set to at least 10 m/min.

In addition, as in the present embodiment, when the first sealing layer 32A and the second sealing layer 33A are formed of the porous abradable material, in a case where an alloy containing a resin material is used as a raw material, for example, a content of the resin material may be changed to change the porosity in the first sealing layer 32A and the second sealing layer 33A. The resin material is thermally sprayed on the preform 31, and is melted at a high temperature. In this manner, a cavity is formed in a portion from which the resin material is removed, and a pore appears. For example, when an alloy mainly containing a CoNiCrAlY alloy and containing polyester is used as in the present embodiment, the content of the polyester is changed.

Specifically, when the first sealing layer 32A is formed, the content of the polyester contained in the raw material of the first sealing layer 32A is a first content T1. Here, for example, it is preferable that the first content T1 is set to 10% by weight≤T1≤20% by weight. The content of the polyester contained in the raw material of the second sealing layer 33A is a second content T2 smaller than the first content T1. Here, for example, it is preferable that the second content T2 is set to 5% by weight≤T2≤15% by weight. In addition, it is preferable that a difference ΔT (=T1−T2) between the first content T1 and the second content T2 is set to at least 5% by weight.

### (Operational Effects)

In the shaft sealing device 10A having the above-described configuration, the sealing member 30A facing the fin 21 includes the first sealing layer 32A and the second sealing layer 33A. The second sealing layer 33A forming the contact surface 33s with the fin 21 has the second porosity H2 lower than the first porosity H1 of the first sealing layer 32A. Therefore, the second sealing layer 33A is denser and harder than the first sealing layer 32A. In this manner, the second sealing layer 33A becomes a harder layer which is less likely to be thinned due to erosion, compared to the first sealing layer 32A. In addition, since the first sealing layer 32A has the porosity higher than that of the second sealing layer 33A, the first sealing layer 32A becomes a softer layer having excellent free-cutting performance, compared to the second sealing layer 33A. That is, the first sealing layer 32A can suppress heat or vibration generated when the fin 21 comes into contact with the first sealing layer 32A. In this way, since the first sealing layer 32A and the second sealing layer 33A are laid up, it is possible to prevent the abradable layer 35 of the sealing member 30A from becoming harder or softer as a whole. As a result, since the first sealing layer 32A and the second sealing layer 33A are laid up, the sealing member 30A can suppress damage caused by erosion, and can improve durability while maintaining free-cutting performance.

In addition, in the sealing member 30A forming the contact surface 33s with the fin 21, an outermost surface layer is formed by the second sealing layer 33A having the low porosity. Therefore, it is possible to enhance an advantageous effect of suppressing possible thinning of the layer due to erosion in a region most exposed to the fluid in the sealing member 30A.

In addition, the difference ΔH in the porosity between the first sealing layer 32A and the second sealing layer 33A is set to be 10% or larger and 40% or smaller. Therefore, balance between free-cutting performance of the first sealing layer 32A (advantageous effect of suppressing heat or vibration generated when the fin 21 comes into contact with the second sealing layer 33A) and erosion resistance of the second sealing layer 33A (advantageous effect of suppressing possible thinning of the second sealing layer 33A due to erosion) can be optimized.

In addition, since the second porosity H2 of the second sealing layer 33A is set to 40% or larger and 50% or smaller, erosion resistance is efficiently improved. In addition, since the first porosity H1 of the first sealing layer 32A is set to 60% or larger and 70% or smaller, which is higher than that of the second sealing layer 33A, free-cutting performance can be efficiently improved.

In addition, the first sealing layer 32A and the second sealing layer 33A are formed of the same material. In this manner, the porosity is different between the first sealing layer 32A and the second sealing layer 33A, even though both are formed of material having the same quality. As a result, it is possible to easily prepare the abradable layer 35 which can suppress damage caused by erosion while maintaining free-cutting performance.

Since the rotary machine 1 having the above-described configuration includes the first sealing layer 32A and the second sealing layer 33A as described above, damage caused by erosion in the shaft sealing device 10A can be suppressed, and durability can be improved.

### Second Embodiment

Next, a second embodiment of a shaft sealing device and a rotary machine according to the present disclosure will be described. In the second embodiment described below, the same reference numerals will be assigned to configurations common to those of the above-described first embodiment in the drawings, and description thereof will be omitted. In the second embodiment, a configuration of a sealing member 30B of a shaft sealing device 10B is different from that in the first embodiment.

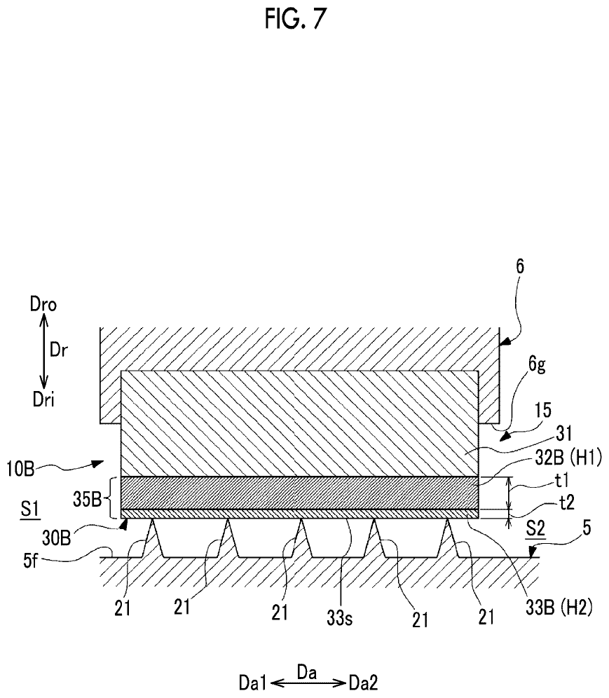

As illustrated in FIG. 7, the shaft sealing device 10B of the rotary machine 1 according to the present embodiment is disposed between the rotor 5 and the stator 6 as in the first embodiment. The shaft sealing device 10B includes the plurality of fins 21 and the sealing member 30B.

### (Configuration of Sealing Member)

In the sealing member 30B, unlike in the first embodiment, thicknesses of a first sealing layer 32B and a second sealing layer 33B are different from each other. In the sealing member 30B of the second embodiment, a thickness t2 of the second sealing layer 33B in the radial direction Dr is smaller than a thickness t1 of the first sealing layer 32B in the radial direction Dr. In the present embodiment, it is preferable that the thickness t2 of the second sealing layer 33B is 10% or larger and 40% or smaller with respect to a sum t1+t2 of the thickness t1 of the first sealing layer 32B and the thickness t2 of the second sealing layer 33B.

### (Operational Effects)

In the shaft sealing device 10B having the above-described configuration, the thickness t2 of the second sealing layer 33B having the low porosity is smaller than the thickness t1 of the first sealing layer 32B. In this manner, a region of the second sealing layer 33B becomes smaller, and free-cutting performance similar to that when the first sealing layer 32B is formed alone can be ensured. Meanwhile, even when the layer is thin, the surface of the first sealing layer 32B is covered with the second sealing layer 33B. Accordingly, erosion resistance can be ensured. As a result, while free-cutting performance is maintained, an abradable layer 35B suppressing damage caused by erosion can be prepared.

In addition, the thickness t2 of the second sealing layer 33B having the low porosity is 10% or larger and 40% or smaller than a sum t1+t2 of the thickness t1 of the first sealing layer 32B and the thickness t2 of the second sealing layer 33B. In this manner, while maximum free-cutting performance is maintained, the abradable layer 35B minimizing damage caused by erosion can be prepared.

In addition, since the porosity is lowered in the second sealing layer 33B, even when the second sealing layer 33B is extremely thin, erosion resistance can be effectively maintained.

### OTHER EMBODIMENTS

Hitherto, the embodiments of the present disclosure have been described in detail with reference to the drawings. However, specific configurations are not limited to the above-described embodiments, and design changes within the scope not departing from the concept of the present disclosure are also included.

In each of the above-described embodiments, the gas turbine has been described as an example of the rotary machine 1, but the rotary machine 1 is not limited to the gas turbine. The rotary machine 1 may be any machine having the rotor 5 and the stator 6. Therefore, for example, the rotary machine 1 may be a steam turbine, a compressor, or a pump.

In addition, in the rotary machine 1, a location for disposing the shaft sealing devices 10A and 10B may be any region as long as sealing is required between the rotor 5 and the stator 6, and is not particularly limited.

In addition, in each of the above-described embodiments, in the second sealing layers 33A and 33B, the contact surface 33s that comes into contact with the plurality of fins 21 is formed in a flat surface shape, but is not limited to this structure. In the second sealing layers 33A and 33B, the contact surface 33s may be an uneven surface such that the contact surface 33s protrudes to the inner side Dri in the radial direction Dr or is recessed to the outer side Dro in the radial direction Dr. In the second sealing layers 33A and 33B, the contact surface 33s may be a curved surface. In this case, both the first sealing layers 32A and 32B and the second sealing layers 33A and 33B may be formed to be uneven or curved to be parallel to the contact surface 33s, and only the second sealing layers 33A and 33B may be formed to be uneven or curved on the flat first sealing layers 32A and 32B.

In addition, the number of installed fins 21, installation positions, and cross-sectional shapes in the circumferential direction Dc may be appropriately changed.

### <Additional Notes>

The shaft sealing devices 10A and 10B and the rotary machine 1 according to the embodiments are understood as follows, for example.

(1) According to a first aspect, there are provided the shaft sealing devices 10A and 10B disposed between the rotor 5 rotatable around the central axis O and the stator 6 disposed on the outer side Dro in the radial direction with respect to the rotor 5, and partitioning the annular space 15 between the outer peripheral surface 5f of the rotor 5 and the inner peripheral surface 6g of the stator 6 into the first side Da1 and the second side Da2 in the axial direction Da in which the central axis O extends. The shaft sealing devices 10A and 10B include the fins 21 protruding from the rotor 5 toward the stator 6 in the radial direction Dr, and the sealing members 30A and 30B facing the fins 21 in the radial direction Dr. The sealing members 30A and 30B include the first sealing layers 32A and 32B formed of the porous abradable material having the first porosity H1, and the second sealing layers 33A and 33B laid up with respect to the first sealing layers 32A and 32B at the position close to the fins 21 to form the contact surface with the fins 21, and formed of the porous abradable material having the second porosity H2 lower than the porosity of the first sealing layers 32A and 32B.

In the shaft sealing devices 10A and 10B, the second sealing layers 33A and 33B are denser and harder than the first sealing layers 32A and 32B. In this manner, the second sealing layers 33A and 33B become harder layers which are less likely to be thinned due to erosion, compared to the first sealing layers 32A and 32B. In addition, since the first sealing layers 32A and 32B have the porosity higher than that of the second sealing layers 33A and 33B, the first sealing layers 32A and 32B become softer layers having excellent free-cutting performance, compared to the second sealing layers 33A and 33B. That is, the first sealing layers 32A and 32B can suppress heat or vibration generated when the fins 21 come into contact with the first sealing layers 32A and 32B. In this way, since the first sealing layers 32A and 32B and the second sealing layers 33A and 33B are laid up, it is possible to prevent the first sealing layers 32A and 32B and the second sealing layers 33A and 33B of the sealing members 30A and 30B from becoming harder or softer as a whole. As a result, since the first sealing layers 32A and 32B and the second sealing layers 33A and 33B are laid up, the sealing members 30A and 30B can suppress damage caused by erosion, and can improve durability while maintaining free-cutting performance.

(2) As the shaft sealing device 10B according to a second aspect, in the shaft sealing device 10B of (1), the thickness t2 of the second sealing layer 33B in the radial direction Dr is smaller than the thickness t1 of the first sealing layer 32B in the radial direction Dr.

In this manner, a region of the second sealing layer 33B becomes smaller, and free-cutting performance similar to that when the first sealing layer 32B is formed alone can be ensured. Meanwhile, even when the layer is thin, the surface of the first sealing layer 32B is covered with the second sealing layer 33B. Accordingly, erosion resistance can be ensured. As a result, while free-cutting performance is maintained, an abradable layer 35B suppressing damage caused by erosion can be prepared.

(3) As the shaft sealing device 10B according to a third aspect, in the shaft sealing device 10B of (2), the thickness t2 of the second sealing layer 33B in the radial direction Dr is 10% or larger and 40% or smaller than the sum t1+t2 of the thicknesses t1 and t2 of the first sealing layer 32B and the second sealing layer 33B in the radial direction Dr.

In this manner, while maximum free-cutting performance is maintained, the abradable layer 35B minimizing damage caused by erosion can be prepared.

(4) As the shaft sealing devices 10A and 10B according to a fourth aspect, in the shaft sealing devices 10A and 10B of (1) or (2), the difference ΔH between the first porosity H1 in the first sealing layers 32A and 32B and the second porosity H2 in the second sealing layers 33A and 33B is 10% or larger and 40% or smaller.

In this manner, balance between free-cutting performance of the first sealing layers 32A and 32B and erosion resistance of the second sealing layers 33A and 33B can be optimized.

(5) As the shaft sealing devices 10A and 10B according to a fifth aspect, in the shaft sealing devices 10A and 10B of any one of (1) to (4), the first porosity H1 in the first sealing layer 32A and 32B is 60% or larger and 70% or smaller, and the second porosity H2 in the second sealing layers 33A and 33B is 40% or larger and 50% or smaller.

In this manner, the second sealing layers 33A and 33B can enhance an advantageous effect of suppressing possible thinning of the second sealing layers 33A and 33B due to erosion. In addition, the first sealing layers 32A and 32B can suppress heat or vibration generated when the fins 21 come into contact with the second sealing layers 33A and 33B.

(6) As the shaft sealing devices 10A and 10B according to a sixth aspect, in the shaft sealing devices 10A and 10B of any one of (1) to (5), the first sealing layers 32A and 32B and the second sealing layers 33A and 33B are formed of the same material.

In this manner, the porosity is different between the first sealing layers 32A and 32B and the second sealing layers 33A and 33B, even though both are formed of a material having the same quality. As a result, it is possible to easily prepare the abradable layer 35 which can suppress damage caused by erosion while maintaining free-cutting performance.

(7) According to a seventh aspect, there is provided the rotary machine 1 including the rotor 5 rotatable around the central axis O, the stator 6 disposed on the outer side Dro in the radial direction Dr of the rotor 5, and the shaft sealing devices 10A and 10B of any one of (1) to (6).

Examples of the rotary machine include the gas turbine, the steam turbine, and the compressor.

In this manner, in the shaft sealing devices 10A and 10B, damage caused by erosion can be suppressed, and durability can be improved.

### INDUSTRIAL APPLICABILITY

According to a shaft sealing device and a rotary machine of the present disclosure, damage caused by erosion can be suppressed, and durability can be improved while free-cutting performance is maintained.

### REFERENCE SIGNS LIST

1: Rotary machine
2: Compressor
3: Combustor
4: Turbine
5; Rotor
5f: Outer peripheral surface
6: Stator
6a: Compressor stator vane
6b: Turbine stator vane
6g: Inner peripheral surface
7a: Compressor rotor vane
7b: Turbine rotor vane
8: Turbine casing
8a, 8b: Bearing portion
9: Compressor casing
9a, 9b: Bearing portion
10A, 10B: Shaft sealing device
15: Annular space
21: Fin
30A, 30B: Sealing member
31: Preform
31f: Surface
32A, 32B: First sealing layer
33A, 33B: Second sealing layer
33s: Contact surface
35, 35B: Abradable layer
100: Thermal spraying gun
Da: Axial direction
Da1: First side
Da2: Second side
Dc: Circumferential direction
Dr: Radial direction
Dri: Inner side
Dro: Outer side
H1: First porosity
H2: Second porosity
O: Central axis
S1: Low-pressure side region
S2: High-pressure side region
T1: First content
T2: Second content
V1: First speed
V2: Second speed
t1: Thickness of first sealing layer
t2: Thickness of second sealing layer
θ1: First angle
θ2: Second angle

1. A method of manufacturing a sealing member configured to reduce leakage of fluid passing through a space between a rotor and a stator disposed outwardly relative to the rotor, wherein the sealing member includes a first sealing layer having a first porosity and a second sealing layer having a second porosity lower than the porosity of the first sealing layer and disposed inwardly relative to the first sealing layer, the method comprising:
a step of forming the first sealing layer by thermally spraying a raw material containing a first content of resin material onto a preform to form the first sealing layer, and
a step of thermally spraying a raw material containing a second content of resin material that is less than the first content onto the first sealing layer.

2. The method of manufacturing the sealing member according to claim 1,
wherein a difference between the first content and the second content is 5% by weight or more.

3. The method of manufacturing the sealing member according to claim 1,
wherein the first content is 10% by weight or more and 20% by weight or less, and
wherein the second content is 5% by weight or more and 15% by weight or less.

4. The method of manufacturing the sealing member according to claim 1,
wherein the resin material is melted by thermal spraying to form cavitiy in the first sealing layer and the second sealing layer.

5. The method of manufacturing the sealing member according to claim 1,
wherein a spraying speed when forming the first sealing layer is higher than a spraying speed when forming the second sealing layer.

6. The method of manufacturing the sealing member according to claim 5,
wherein a difference between the spraying speed when forming the first sealing layer and the spraying speed when forming the second sealing layer is 10 m/min or more.

7. The method of manufacturing the sealing member according to claim 5,
wherein the spraying speed when forming the first sealing layer is 40 m/min or more and 50 m/min or less, and the spraying speed when forming the second sealing layer is 20 m/min or more and 30 m/min or less.

8. The method of manufacturing the sealing member according to claim 1,
wherein a thermal spraying angle when forming the first sealing layer is larger than a thermal spraying angle when forming the second sealing layer.

9. The method of manufacturing the sealing member according to claim 8,
wherein a difference between the thermal spraying angle when forming the first sealing layer and the thermal spraying angle when forming the second sealing layer is 20° or more.

10. The method of manufacturing the sealing member according to claim 8,
wherein the thermal spraying angle when forming the first sealing layer is 70° or more and 90° or less, and the thermal spraying angle when forming the second sealing layer is 50° or more and 60° or less.

11. A method of controlling a porosity of a seal layer formed on a surface of a sealing member, which configured to reduce leakage of fluid passing through a space between a rotor and a stator disposed outwardly relative to the rotor,
wherein the porosity is controlled by a content of a resin material in a raw material to be thermal sprayed and a thermal spraying speed and/or a thermal spraying angle.

12. The method of controlling the porosity of the seal layer according to claim 11,
wherein the porosity of a plurality of sealing layers including the seal layer is controlled, and a difference in the content of the resin material between the plurality of sealing layers is set to at least 5% by weight.
